(19) United States
(12) Patent Application Publication
(10) Pub. No.: US 2025/0271587 A1
(43) Pub. Date: Aug. 28, 2025

(54) METHOD FOR DIFFERENTIATING CARBONATES AND VOLCANOES IN SEISMIC DATA

(71) Applicant: Landmark Graphics Corporation, Houston, TX (US)

(72) Inventors: Andrew Davies, Abingdon (GB); Julianna Toms, Houston, TX (US); Konstantin Osypov, Houston, TX (US)

(73) Assignee: Landmark Graphics Corporation, Houston, TX (US)

(21) Appl. No.: 19/062,343

(22) Filed: Feb. 25, 2025

Related U.S. Application Data
(60) Provisional application No. 63/558,349, filed on Feb. 27, 2024.

(51) Int. Cl. G01V 1/50; G01V 1/18

(52) U.S. Cl. CPC G01V 1/50; G01V 1/186; G01V 2210/1293; G01V 2210/1423; G01V 2210/667

(57) ABSTRACT

A method for analyzing seismic data of a subterranean formation includes obtaining the seismic data and identifying one or more potential carbonate buildups in the seismic data. Further, historical paleoclimate data for the formation of the one or more potential carbonate buildups is obtained, and the seismic data and the historical paleoclimate data are processed to generate a plurality of parameter scores for a plurality of characteristics of the formation; A weighted sum calculating scores is calculated using a plurality of parameter weights.

### BACKGROUND

The oil and gas industry may use wellbores as fluid conduits to access subterranean deposits of various fluids and minerals which may include hydrocarbons. A drilling operation may be utilized to construct the fluid conduits which are capable of producing hydrocarbons disposed in subterranean formations. Wellbores may be constructed, in increments, as tapered sections, which sequentially extend into a subterranean formation.

### BRIEF DESCRIPTION OF DRAWINGS

These drawings illustrate certain aspects of some examples of the present disclosure and should not be used to limit or define the disclosure.

FIG. 1 is a diagram of an example surveying environment.

FIG. 2 is a diagram of an example computing environment.

FIG. 3 is a flowchart of a method for identifying a feature in a subterranean formation.

FIG. 4A is an image of a visualization of seismic data showing potential carbonate buildups.

FIG. 4B is an image of a visualization of seismic data showing potential carbonate buildups.

FIG. 5A is a map of a geographic region with zones indicating likelihood of carbonate buildup existence.

FIG. 5B is a map of a geographic region with zones indicating likelihood of carbonate buildup existence.

FIG. 6A is an image of a visualization of seismic data showing a potential carbonate buildup and surrounding (largely parallel) fault lines.

FIG. 6B is an image of a visualization of seismic data showing a potential carbonate buildup and surrounding (largely radial) fault lines.

FIG. 7A is an image of a visualization of amplitude extraction from seismic data showing features indicative of carbonate buildup.

FIG. 7B is an image of a visualization of amplitude extraction from seismic data showing features indicative of volcanic structures.

FIG. 8 shows a bathymetric distribution of modern carbonate buildups at varying depths.

FIG. 9A is an image of a visualization of seismic data showing intrusions.

FIG. 9B is an image of a visualization of seismic data showing intrusions.

FIG. 10A is an image of a visualization of seismic data showing continuous sediment layers below of potential carbonate buildup.

FIG. 10B is an image of a visualization of seismic data showing a shadow zone below of potential carbonate buildup.

FIG. 11 is a bar chart showing the relative weight given to each parameter used to analyze the provided data.

FIG. 12 is a table showing values calculated or assigned to each parameter for multiple use cases and examples of analyzed seismic data.

### DETAILED DESCRIPTION

In general, this application discloses one or more examples of methods and systems for using seismic (and non-seismic) data to provide a likelihood of a subterranean formation being a carbonate buildup or volcanic structure, prior to drilling

When analyzing seismic data, the presence of potential carbonate buildups may indicate the existence of hydrocarbon reservoirs or subsurface storage. However, volcanic structures (lacking any desired hydrocarbons) may be misidentified as carbonate buildups in the seismic data.

Conventionally, potential carbonate buildups must be accessed (e.g., by drilling) to definitively identify the features of a subterranean formation. In such cases, if drilling ultimately reveals volcanic structures (and not the desired hydrocarbon reservoir), considerable time and resources are wasted accessing the formation. Accordingly, it may be desirable to better identify the type of feature earlier (e.g., before drilling) to avoid such (potentially) unnecessary expenses. The present disclosure provides a practical application for avoiding unnecessary drilling, and allow for altering the pathway of a borehole through a formation to access productive regions and steer around unproductive regions.

As disclosed relative to one or more examples described herein, additional analysis of the seismic and non-seismic data (acquired before drilling), allows for better identification of features (i.e., as carbonate buildups or volcanic structures) in a subterranean formation. Further, a machine learning model may be trained to interpret seismic and non-seismic data of the geographic region and provide a statistical likelihood of the type of formation. In turn, such an analysis may then be used to determine whether to continue further exploration of the site. The data analysis may further allow for a rotatably steerable system (RSS) to alter a pathway through a formation to avoid unnecessary drilling.

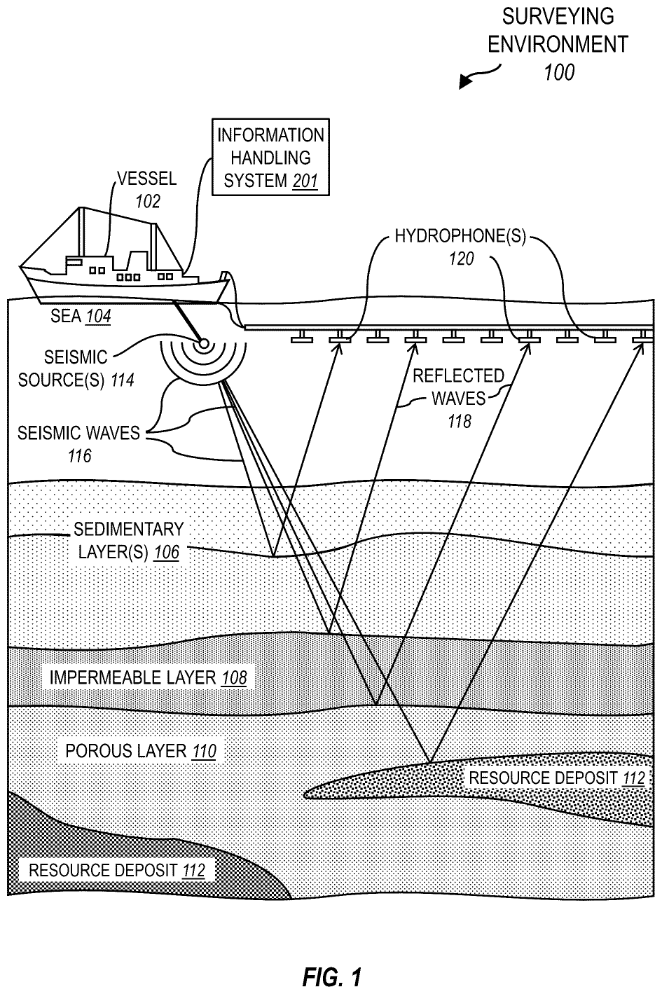

FIG. 1 is a diagram of an example surveying environment. Surveying environment 100 may include vessel 102 on sea 104, using seismology to generate and collect data related to one or more resource deposit(s) 112. Each of these components is described below.

Vessel 102 is a structure used to support one or more seismic source(s) 114 and one or more hydrophone(s) 120. In any implementation, vessel 102 may be less dense than the liquid composing sea 104, and therefore vessel 102 will have buoyancy sufficient to prevent the entirety of vessel 102 from submerging into sea 104. Vessel 102 may navigate on the surface of sea 104 to move one or more seismic source(s) 114 and one or more hydrophone(s) 120 to regions where seismic data may be collected (e.g., into information handling system 201).

Sea 104 is a body of (mostly) water, upon which vessel 102 may float. In any implementation, non-limiting examples of sea 104 include an ocean, gulf, lake, pond, reservoir, river, and stream.

Sedimentary layer 106 is a collection of minerals (e.g., rocks) and/or organic matter forming a seabed in sea 104. Sedimentary layer 106 is porous as the liquid(s) of sea 104 may interstitially penetrate between the individual objects forming sedimentary layer 106.

Impermeable layer 108 is a formation of nonporous rock through which the liquid(s) of sea 104 cannot penetrate. In any example, impermeable layer 108 separates two porous layers (e.g., sedimentary layer 106, porous layer 110). Impermeable layer 108 may act to prevent the diffusion of fluids in one or more resource deposit(s) 112 with sea 104, as the fluids thereof are kept physically isolated by the low porosity of impermeable layer 108.

Porous layer 110 is a formation of rocks which allows for the flow of fluids (i.e., gases and/or liquids) to move therein. A non-limiting example of porous layer 110 is an aquifer providing for the movement and storage of groundwater. In any example, porous layer 110 allows for the movement and storage of resource deposit(s) 112.

Resource deposit 112 is an aggregation of matter, where the matter may store energy in the chemical bonds (i.e., a resource). Non-limiting examples of a resource are any fluid hydrocarbon (e.g., petroleum, natural gas, etc.).

Seismic source 114 is a hardware device which generates seismic waves 116. In any example, seismic source 114 may be controlled via information handling system 201 and periodically generate seismic waves 116 (e.g., on a schedule, and/or manually activated by a user). Non-limiting examples of seismic source 114 include a seismic air gun which releases a burst of compressed gas, an electrical discharge sound device (e.g., boomers, sparkers, etc.), and a sonic navigation and ranging (sonar) device.

Seismic waves 116 are acoustic waves, generated from seismic source 114, manifesting as changes in pressure (e.g., changes in the density of fluid(s)) that propagate through sea 104, sedimentary layer(s) 106, impermeable layer 108, porous layer 110, and resource deposit(s) 112. Seismic waves 116 may travel in all directions from seismic source 114 (e.g., spherically outward).

Reflected waves 118 are seismic waves 116 that have reflected (e.g., “bounced”) off one or more object(s) in sea 104, sedimentary layer(s) 106, impermeable layer 108, porous layer 110, or resource deposit(s) 112. In any example, after reflecting, reflected waves 118 may be (re) directed in all directions (e.g., spherically outward), including towards hydrophone(s) 120. When seismic waves 116 interact and reflect off one or more objects in the various layer(s), the resulting reflected waves 118 may be altered (via a change in amplitude, frequency, etc.) from the original seismic waves 116. As non-limiting examples, (unaltered) seismic waves 116 may have a different frequency, phase, and/or amplitude than reflected waves 118 emanating from impermeable layer 108, which may also have a different frequency than reflected waves 118 emanating from resource deposit 112. Additionally, in any example, reflected waves 118 that penetrate further into the various layers (e.g., into porous layer 110) may take a longer duration to travel deeper, reflect off of an object, travel back upward, and impact hydrophone 120, compared to reflected waves 118 that bounce back from a shallower depth (e.g., in sedimentary layer 106).

Hydrophone 120 is a hardware device (e.g., a microphone) which detects sounds in a liquid environment (e.g., seismic waves 116, reflected waves 118). Hydrophone 120 may work by detecting changes in pressure caused by sounds (e.g., from seismic waves 116, reflected waves 118) and converting those detected pressure changes into data. In any example, hydrophone 120 may be configured to detect the amplitude, frequency, and/or time of detected sounds. Hydrophone 120 may be operatively connected to information handling system 201, where generated data may be stored.

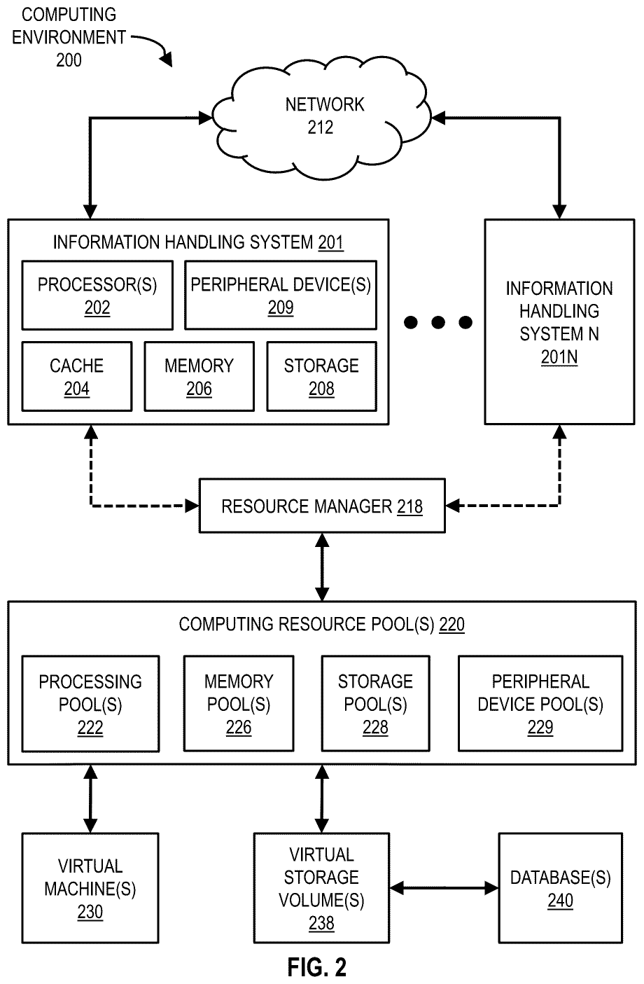

Information handling system 201 is a hardware computing system which may be operatively connected to vessel 102 (and/or other various components of the surveying environment 100). In any example, information handling system 201 may utilize any suitable form of wired and/or wireless communication to send and/or receive data to and/or from other components of surveying environment 100. In any example, information handling system 201 may receive a digital telemetry signal, demodulate the signal, display data (e.g., via a visual output device), and/or store the data. In any example, information handling system 201 may send a signal (with data) to one or more components of surveying environment 100 (e.g., to control seismic source 114, hydrophone(s) 120, vessel 102, etc.). Additional details regarding information handling system 201 are in the description for FIG. 2.

FIG. 2 is a diagram of an example computing environment. Computing environment 200 may include one or more information handling system(s) 201 connected via network 212. Further, resource manager 218 may aggregate and manage the allocation of the computing resources (of one or more information handling system(s) 201) into computing resource pool(s) 220. Those computing resource pool(s) 220 may then be allocated to various virtualized and/or logical components (e.g., virtual machine(s) 230, virtual storage volume(s) 238, etc.). Each of these components is described below.

Information handling system 201 is a hardware computing device which may be utilized to perform various steps, methods, and techniques disclosed herein (e.g., via the execution of software). In any example, information handling system 201 may include one or more processor(s) 202, cache 204, memory 206, storage 208, and/or one or more peripheral device(s) 209. Any two or more of these components may be operatively connected via a system bus (not shown) that provides a means for transferring data between those components. Although each component is depicted and disclosed as individual functional components, these individual components may be combined (or divided) into any combination or configuration of components.

A system bus is a system of hardware connections (e.g., sockets, ports, wiring, conductive tracings on a printed circuit board (PCB), etc.) used for sending (and receiving) data to (and from) each of the components connected thereto. In any example, a system bus allows for communication via an interface and protocol (e.g., inter-integrated circuit (I2C), peripheral component interconnect (express) (PCI(e)) fabric, etc.) that may be commonly recognized by the components utilizing the system bus. In any example, a basic input/output system (BIOS) may be configured to transfer information between the components using the system bus (e.g., during initialization of information handling system 201).

In any example, information handling system 201 may additionally include internal physical interface(s) (e.g., serial advanced technology attachment (SATA) ports, peripheral component interconnect (PCI) ports, PCI express (PCIe) ports, next generation form factor (NGFF) ports, M.2 ports, etc.) and/or external physical interface(s) (e.g., universal serial bus (USB) ports, recommended standard (RS) serial ports, audio/visual ports, etc.). Internal physical interface(s) and external physical interface(s) may facilitate the operative connection to one or more peripheral device(s) 209.

Non-limiting examples of information handling system 201 include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device with the aforementioned capabilities. Further, information handling system 201 may be operatively connected to another information handling system 201 via network 212 in a distributed computing environment. As used herein, a “computing device” may be equivalent to an information handling system.

Processor 202 is a hardware device which may take the form of an integrated circuit configured to process computer-executable instructions (e.g., software). Processor 202 may execute (e.g., read and process) computer-executable instructions stored in cache 204, memory 206, and/or storage 208. Processor 202 may be a self-contained computing system, including a system bus, memory, cache, and/or any other components of a computing device. Processor 202 may include multiple processors, such as a system having multiple physically separate processors in different sockets, or a system having multiple processor cores on a single physical chip. A multi-core processor may be symmetric or asymmetric. Multiple processors 202, and/or processor cores thereof, may share resources (e.g., cache 204, memory 206) or may operate using independent resources.

Non-limiting examples of processor 202 include general-purpose processor (e.g., a central processing unit (CPU)), an application specific integrated circuit (ASIC), a programmable gate array (PGA), a field programmable gate array (FPGA), a digital signal processor (DSP), and any digital or analog circuit configured to perform operations based on input data (e.g., execute program instructions).

Cache 204 is one or more hardware device(s) capable of storing digital information (e.g., data) in a non-transitory medium. Cache 204 expressly excludes transitory media (e.g., transitory waves, energy, carrier signals, electromagnetic waves, signals per se, etc.). Cache 204 may be considered “high-speed”, having comparatively faster read/write access than memory 206 and storage 208, and therefore utilized by processor 202 to process data more quickly than data stored in memory 206 or storage 208. Accordingly, processor 202 may copy needed data to cache 204 (from memory 206 and/or storage 208) for comparatively speedier access when processing that data. In any example, cache 204 may be included in processor 202 (e.g., as a subcomponent). In any example, cache 204 may be physically independent, but operatively connected to processor 202.

Memory 206 is one or more hardware device(s) capable of storing digital information (e.g., data) in a non-transitory medium. Memory 206 expressly excludes transitory media (e.g., transitory waves, energy, carrier signals, electromagnetic waves, signals per se, etc.). In any example, when accessing memory 206, software (executed via processor 202) may be capable of reading and writing data at the smallest units of data normally accessible (e.g., “bytes”). Specifically, memory 206 may include a unique physical address for each byte stored thereon, thereby enabling the ability to access and manipulate (read and write) data by directing commands to a specific physical address associated with a byte of data (i.e., “random access”). Non-limiting examples of memory 206 devices include flash memory, random access memory (RAM), dynamic RAM (DRAM), static RAM (SRAM), resistive RAM (ReRAM), read-only memory (ROM), and electrically erasable programmable ROM (EEPROM). In any example, memory 206 devices may be volatile or non-volatile.

Storage 208 is one or more hardware device(s) capable of storing digital information (e.g., data) in a non-transitory medium. Storage 208 expressly excludes transitory media (e.g., transitory waves, energy, carrier signals, electromagnetic waves, signals per se, etc.). In any example, the smallest unit of data readable from storage 208 may be a “block” (instead of a “byte”). Prior to reading and/or manipulating the data on storage 208, one or more block(s) may be copied to an intermediary storage medium (e.g., cache 204, memory 206) where the data may then be accessed in “bytes” (e.g., via random access). In any example, data on storage 208 may be accessed in “bytes” (like memory 206). Non-limiting examples of storage 208 include integrated circuit storage devices (e.g., a solid-state drive (SSD), Non-Volatile Memory Express (NVMe), flash memory, etc.), magnetic storage devices (e.g., a hard disk drive (HDD), floppy disk, magnetic tape, diskette, cassettes, etc.), optical media (e.g., a compact disc (CD), digital versatile disc (DVD), etc.), and printed media (e.g., barcode, quick response (QR) code, punch card, etc.).

As used herein, “non-transitory computer readable medium” may include cache 204, memory 206, storage 208, and/or any other hardware device capable of non-transitorily storing and/or carrying data.

Peripheral device 209 is a hardware device configured to send (and/or receive) data to (and/or from) information handling system 201 via one or more internal and/or external physical interface(s). Any peripheral device 209 may be categorized as one or more “types” of computing devices (e.g., an “input” device, “output” device, “communication” device, etc.). However, such categories are not comprehensive and are not mutually exclusive. Such categories are listed herein strictly to provide understandable groupings of the potential types of peripheral devices 209. As such, peripheral device 209 may be an input device, an output device, a communication device, and/or any other optional computing component.

An input device is a hardware device that receives data into information handling system 201. In any example, an input device may be a human interface device which facilitates user interaction by collecting data based on user inputs (e.g., a mouse, keyboard, camera, microphone, touchpad, touchscreen, fingerprint reader, joystick, gamepad, etc.). In any example, an input device may collect data based on raw inputs, regardless of human interaction (e.g., any sensor, logging tool, audio/video capture card, etc.). In any example, an input device may be a reader for accessing data on a non-transitory computer readable medium (e.g., a CD drive, floppy disk drive, tape drive, scanner, etc.).

An output device is a hardware device that sends data from information handling system 201. In any example, an output device may be a human interface device which facilitates providing data to a user (e.g., a visual display monitor, speakers, printer, status light, haptic feedback device, etc.). In any example, an output device may be a writer for facilitating storage of data on a non-transitory computer readable medium (e.g., a CD drive, floppy disk drive, magnetic tape drive, printer, etc.).

A communication device is a hardware device capable of sending and/or receiving data with one or more other communication device(s) (e.g., connected to another information handling system 201 via network 212). A communication device may communicate via any suitable form of wired interface (e.g., Ethernet, fiber optic, serial communication etc.) and/or wireless interface (e.g., Wi-Fi® (Institute of Electrical and Electronics Engineers (IEEE) 802.11), Bluetooth® (IEEE 802.15.1), etc.) and utilize one or more protocol(s) for the transmission and receipt of data (e.g., transmission control protocol (TCP), user datagram protocol (UDP), internet protocol (IP), remote direct memory access (RDMA), etc.). Non-limiting examples of a communication device include a network interface card (NIC), a modem, an Ethernet card/adapter, and a Wi-Fi® card/adapter.

An optional computing component is any hardware device that operatively connects to information handling system 201 and extends the capabilities of information handling system 201. Non-limiting examples of an optional computing components include a graphics processing unit (GPU), a data processing unit (DPU), and a docking station.

As used herein, “software” (e.g., “code”, “algorithm”, “application”, “routine”) is data in the form of computer-executable instructions. Processor 202 may execute (e.g., read and process) software to perform one or more function(s). Non-limiting examples of functions may include reading existing data, modifying existing data, generating new data, and using any capability of information handling system 201 (e.g., reading existing data from memory 206, generating new data from the existing data, sending the generated data to a GPU to be displayed on a monitor). Although software physically persists in cache 204, memory 206, and/or storage 208, one or more software instances may be depicted, in the figures, as an external component of any information handling system 201 that interacts with one or more information handling system(s) 201.

Network 212 is a collection of connected information handling systems (e.g., 201, 201N) that allows for the exchange of data and/or the sharing of computing resources therebetween. Non-limiting examples of network 212 include a local area network (LAN), a wide area network (WAN) (e.g., the Internet), a mobile network, any combination thereof, and any other type of network that allows for the communication of data and sharing of resources among computing devices operatively connected thereto. A person of ordinary skill in the relevant art, having the benefit of this detailed description, would appreciate that a network is a collection of operatively connected computing devices that enables communication between those computing devices.

As used herein, “computing resource” refers to the functional capabilities (and/or portions of functional capabilities) of any component of information handling system 201. As an example, processor 202 may have “processor resources” which may be divided into slices of processor time, any of which may be considered a “computing resource”. Cache 204, memory 206, and storage 208 may each be categorized into their own type of “computing resource”, as well as any smaller increment of storage therein (e.g., “bytes”, “blocks”). As a non-limiting example, a single memory 206 device may be divided into ranges of bytes that may be separately allocated. The storage capacity of the entire memory 206 device may be considered a “computing resource”, and any subdivision (byte range) thereof may also be considered a “computing resource”. As another non-limiting example, a network interface card may have a total throughput capacity, that total throughput may be divided into portions of bandwidth. The entire throughput may be considered a “computing resource”, and any smaller portion of bandwidth may also be considered a “computing resource”.

Resource manager 218 is a software instance that manages the allocation of computing resources. In any example, resource manager 218 is configured (i.e., programmed) to query one or more information handling system(s) 201 to identify the computing resources available therein, and in turn, may aggregate those computing resources into one or more computing resource pool(s) 220, per the type of computing resource. Resource manager 218 may use one or more database(s) (e.g., database 240) to track the availability, allocation, and/or utilization of computing resources (e.g., as computing resource pools(s) 220). In any example, resource manager 218 may create, initialize, stop, and/or terminate one or more virtual machine(s) 230, software container(s), virtual storage volume(s) 238, and/or database(s) 240. Non-limiting examples of resource manager 218 include any orchestrator, hypervisor, and/or container manager.

Computing resource pool 220 is a data structure that includes one or more pool(s) for specific types of computing resources (e.g., processing pool(s) 222, memory pool(s) 226, storage pool(s) 228, peripheral device pool(s) 229, etc.). In any example, computing resource pool 220 is a data structure, created and/or managed by resource manager 218, which tracks the various computing resources of information handling systems 201 in computing environment 200. Computing resource pool(s) 220 may take the form of a table, file, and/or any other data structure capable of including information relevant to computing resources.

Processing pool 222 is a data structure that includes an aggregation of the capabilities and/or functionalities of one or more processor(s) 202 in one or more information handling system(s) 201. In any example, processing pool 222, may present a unified virtual computing resource which may be allocated, by resource manager 218, to any software (e.g., virtual machine 230) and/or virtual storage volume 238.

Memory pool 226 is a data structure that includes an aggregation of the capabilities and/or functionalities of one or more memory 206 device(s) in one or more information handling system(s) 201. In any example, memory pool 226, may present a unified virtual computing resource which may be allocated, by resource manager 218, to any software (e.g., virtual machine 230) and/or virtual storage volume 238.

Storage pool 228 is a data structure that includes an aggregation of the capabilities and/or functionalities of one or more storage 208 device(s) in one or more information handling system(s) 201. In any example, storage pool 228, may present a unified virtual computing resource which may be allocated, by resource manager 218, to any software (e.g., virtual machine 230) and/or virtual storage volume 238.

Peripheral device pool 229 is a data structure that includes an aggregation of the capabilities and/or functionalities of one or more peripheral device(s) 209 in one or more information handling system(s) 201. In any example, peripheral device pool 229, may present a unified virtual computing resource which may be allocated, by resource manager 218, to any software (e.g., virtual machine 230) and/or virtual storage volume 238.

Virtual machine 230 is a software instance which provides a virtual environment in which other software may execute. In any example, virtual machine 230 may be created by resource manager 218, where resource manager 218 allocates some portion of computing resources (e.g., in one or more computing resource pool(s) 220) to virtual machine 230 to initialize and execute. In any example, within virtual machine 230, the computing resources may be aggregated from one or more information handling system(s) 201 (e.g., via computing resource pool(s) 220) and presented as unified “virtual” resources within virtual machine 230 (e.g., virtual processor(s), virtual memory, virtual storage, virtual peripheral device(s), etc.). As computing resource pool(s) 220 are used to generate virtual machine 230, the underlying hardware storing, executing, and processing the operations (of virtual machine 230) may disposed in any number of information handling system(s) 201.

Virtual storage volume 238 is a virtual space for storing data. In any example, virtual storage volume 238 may use any suitable means of underlying device(s) for storing data (e.g., cache 204, memory 206, storage 208) via one or more computing resource pool(s) 220. In any example, virtual storage volume 238 may be managed by virtual machine 230, where virtual machine 230 handles the access (reads/writes), filesystem, redundancy, and addressability of the data stored therein.

Database 240 is a data structure that stores information in relational tuples and attributes. In any example, database 240 may be stored on virtual storage volume 238 and/or directly on a single information handling system 201. Non-limiting examples of database 240 include one or more table(s) each with one or more “row(s)” (e.g., tuple(s)) and “column(s)” (e.g., attribute(s)), a structured file for storing tabular data (e.g., a comma-separated value (CSV) file, a tab-separated value (TSV) file, etc.), a relational database management system (RDBMS) (e.g., using Structured Query Language (SQL)), and/or any other data structure capable of storing data.

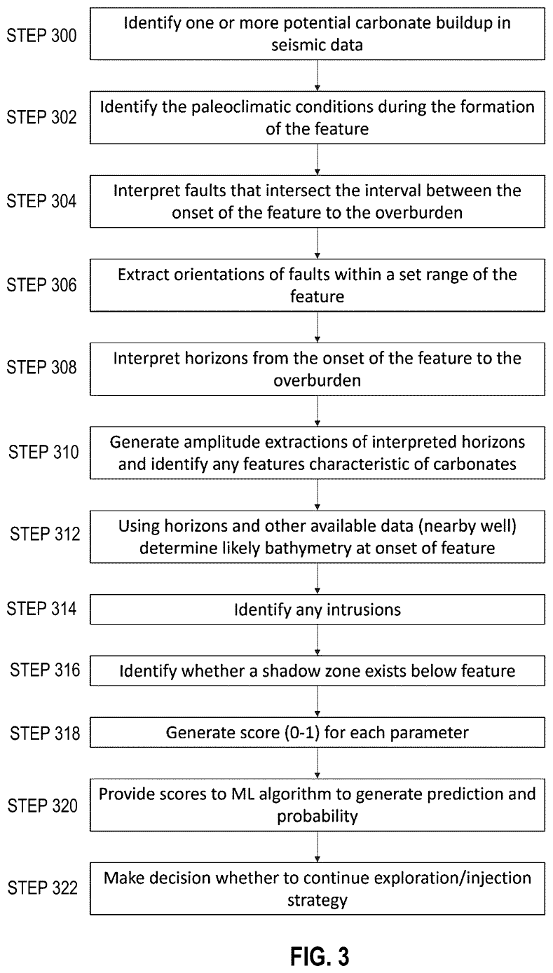

FIG. 3 is a flowchart of a method for identifying a feature of a subterranean formation. All or a portion of the method shown may be performed by one or more components of information handling system 201 (see description in FIG. 2) or a user thereof. While the various steps in this flowchart are presented and described sequentially, a person of ordinary skill in the relevant art (having the benefit of this detailed description) would appreciate that some or all steps may be executed in different orders, combined, or omitted, and some or all steps may be executed in parallel.

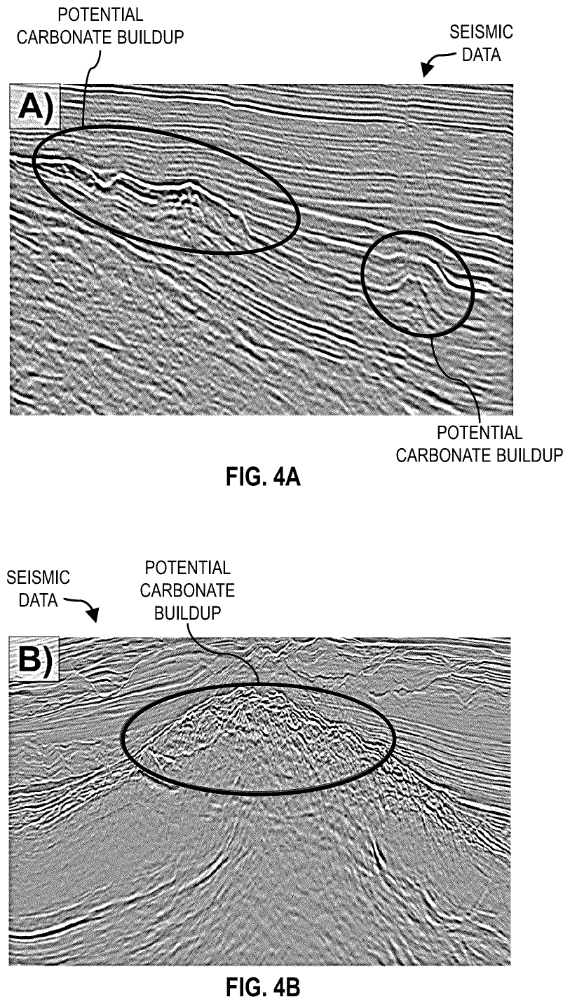

In Step 300, seismic data is obtained, and one or more potential carbonate buildup(s) are identified. Examples of seismic data and potential carbonate buildups may be seen in FIG. 4A and FIG. 4B.

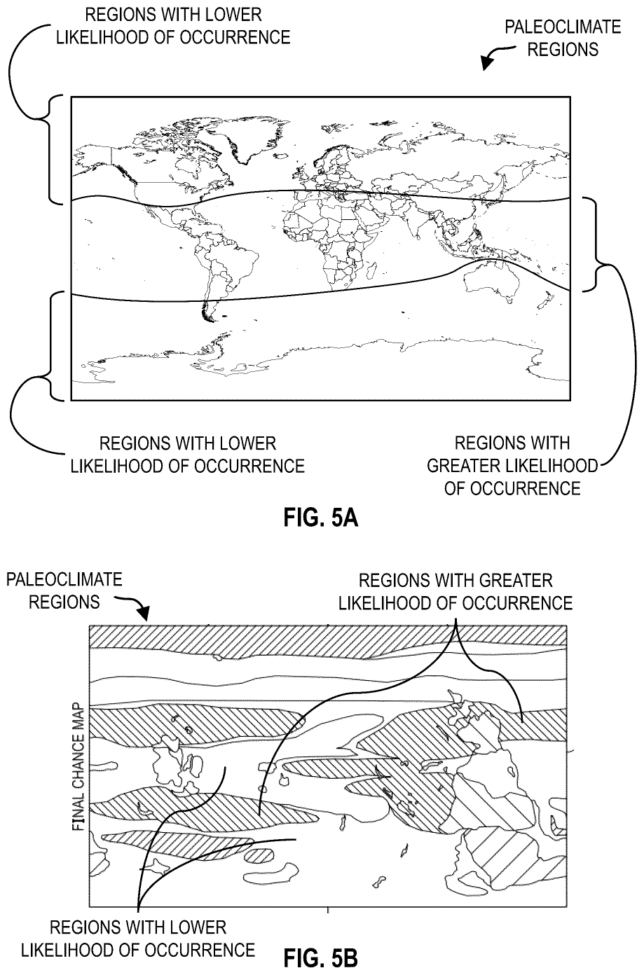

In Step 302, the paleoclimatic conditions during the formation of the subterranean region are identified. An example of paleoclimates may be seen in FIGS. 5A and 5B. In one or more examples, carbonate buildups may be temperature controlled, with modern coral-bearing photozoan carbonate assemblages constrained to tropical/subtropical environments where sea surface temperatures remain above 18° C. (64.4° F.) in the coldest month. In one or more examples, temperature may have a crucial role in controlling the geographical distribution of photozoan carbonate assemblages, as temperature may influence the energy required to generate skeletal carbonate by impacting the solubility of CO₂ and the saturation of CaCO₃ in seawater. As temperature may be considered proportional to latitude, this parameter can be approximated by determining the palaeolatitudinal position of the feature of interest (e.g., FIG. 5A and FIG. 5B). For this, it is necessary to know the current geographic position and the approximate age of the feature of interest. With these data it may be possible to determine the paleolatitude using a plate tectonic model. As the latitudinal temperature gradient varies spatially and temporally, it may be better to use the results of paleoclimate simulations which provide a more nuanced view. From paleoclimate simulations it may be possible to obtain information on the cold month mean sea surface temperature at any locality. Further, while temperature may play a role in photozoan carbonate distribution, other factors such as trophic level may also be important. Therefore, multiple climate factors can be accounted for here by using a carbonate likelihood maps (e.g. FIG. 5A and FIG. 5B). In one or more examples, a paleoclimate region map (e.g., FIG. 5A and FIG. 5B) or other paleoclimate region data (not necessarily in the form of a visual map) may be generated through machine learning. A score is then generated for the paleoclimate suitability for carbonate build-ups to form, with 1 for perfect conditions and 0 for conditions not conducive for carbonate build up formation.

In Step 304, processing the seismic data includes identifying azimuthal attributes in the seismic data, wherein the azimuthal attributes may represent azimuthal features with respect to faults and fractures in a subterranean formation represented by the seismic data. Faults represented in the seismic data that intersect the interval between the onset of the feature of interest to overburden may then be identified and interpreted. As used herein, the term “overburden” refers to a layer or layers of material which may vary in depth from a few centimeters to hundreds of meters over a feature of interest. Also, the term “overburden signature” refers to information describing the nature and composition of the overburden. In one or more examples, the seismic data may be filtered (or otherwise processed and/or narrowed) to focus on data relevant to a feature of interest (e.g., in sediments underlying, contemporaneous and overlying within a fixed radius, such as 5 km). Fault planes may be interpreted manually or using automated approaches.

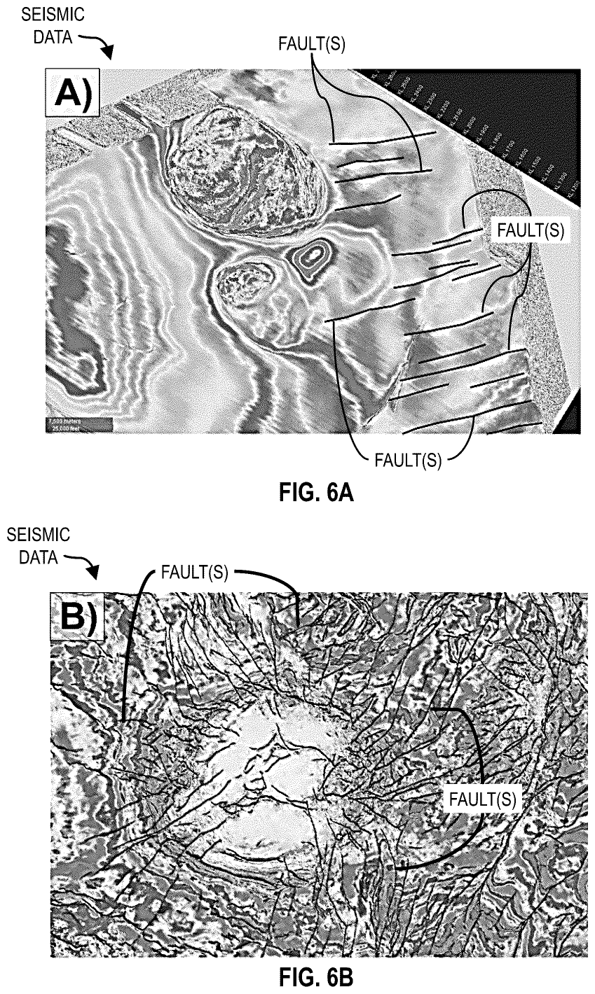

In Step 306, the seismic data is assessed to determine whether faults (within the vicinity of the feature of interest) are disposed in a radial pattern (e.g., FIG. 6A shows parallel faults, FIG. 6B shows radials faults). With the fault planes interpreted (Step 302), it may then be possible to define whether the pattern is radial. Alternatively, it is also possible to calculate the orientation of each fault (e.g., 0° is equal to north, 90° degrees is equal to cast). These data may then be analyzed in an automated approach, such as the calculation of circular variance, which provides a value of 0-1, with 1 representative of a radial pattern and 0 a non-radial pattern.

In Step 308, horizons are interpreted through and above the feature of interest. In one or more examples, seismic data may be interpreted visually (and/or with machine aid) to identify coherent stratigraphic layers present. In one or more examples, such layers may indicate the presence of carbonate buildups.

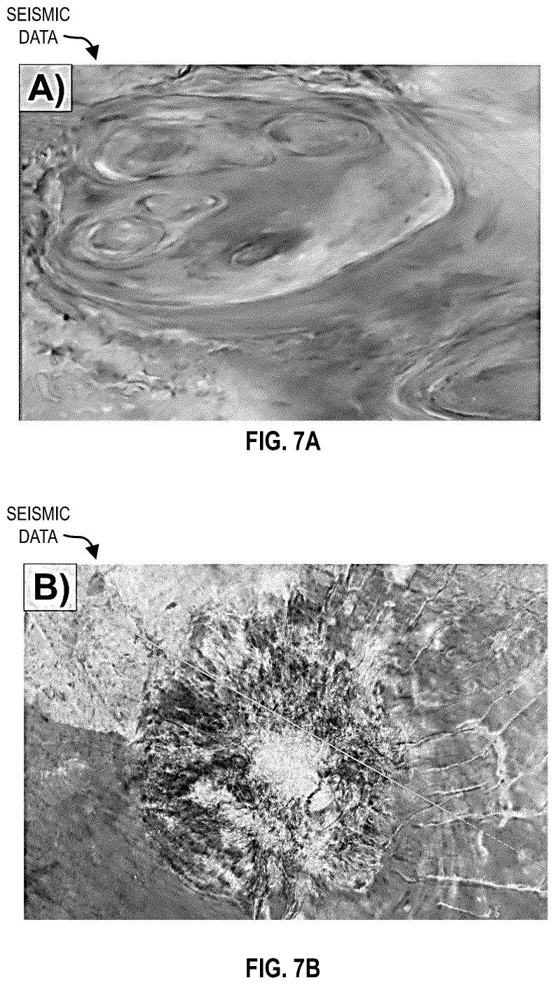

In Step 310, amplitude extractions (e.g., FIG. 7A and FIG. 7B) (or another useful seismic attribute) are generated from the interpreted horizons. In one or more examples, amplitude extractions may then be analyzed to identify features representative of carbonate buildups such as karst, pinnacle reefs, lagoons, barriers (FIG. 7A and FIG. 7B). A score is then generated for the presence of features representative of carbonate buildups, which can be done manually or through automated processes, such as the use of machine learning.

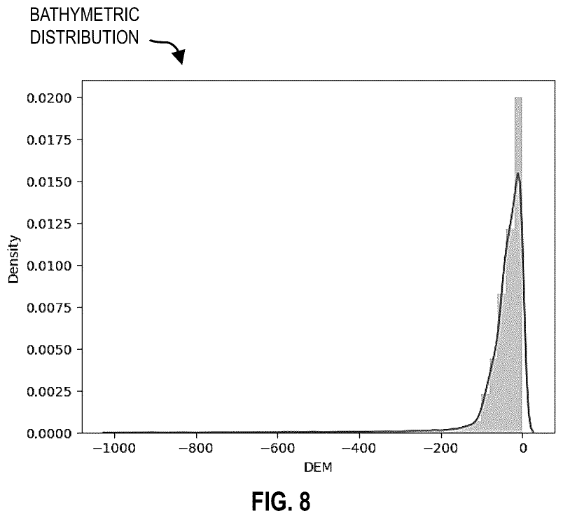

In Step 312, likely bathymetry at onset of the subterranean formation is identified. In one or more examples, the organisms responsible for creating carbonate buildups may be photosynthetic, and the structures only form in a narrow band of water depths. Most buildups occur in water depths of 0-20 meters (0-65.6 feet) and occur no deeper than 200 meters (656 feet) (sec e.g., FIG. 8). In one or more examples, interpreted horizons may then be used to generate an interpretation of the paleobathymetry at the onset of the feature of interest, using a technique such as backtracking. In one or more examples, backtracking calculates paleo-water depths from a model of tectonic subsidence by adding the isostatic contributions of decompacted sediments over time. The additional impacts of sediment loading, flexural isostasy, dynamic topography and eustatic sea level change may also be included. Further, decompaction is a step to restore the porosity loss due to mechanical compaction during burial. This is achieved through a representative compaction curve (which may also include an exhumation magnitude) using a porosity-depth curve.

Tectonic subsidence is the result of thinning of the lithosphere causing hot asthenospheric material to rise. As this material cools it becomes denser and hence subsides. Tectonic subsidence can be calculated using knowledge of the time of rifting, the crustal stretching factor, and a model of thermal decay. The weight of deposited sediment also causes crustal depression and hence subsidence. This sediment loading effect and the resulting flexural isostatic response of the crust can be calculated and accounted for. The complex convection patterns in the Earth's mantle, driven by zones of differing buoyancy, also result in uplift or subsidence of the crust. Geodynamic models can be used to quantify this dynamic topographic effect through time.

The volume of ocean basins and the amount of water in them has varied throughout Earth's past. The resulting global sea level changes (eustasy) may have also impacted past water depth. Such factors may be accounted for using various eustatic curves. In one or more examples, another step of calculating paleobathymetry may be to calibrate the resulting models to any observational data such as biostratigraphic assemblages or diagnostic depositional facies from nearby wells, or characteristic features in the seismic data, such as shelf edges or coastal onlaps. The paleobathymetry at the onset of the feature can then be used to generate a score (e.g., 0 for depths greater than 200 m or above sea level, 1 for depths 0-20 m) for this parameter.

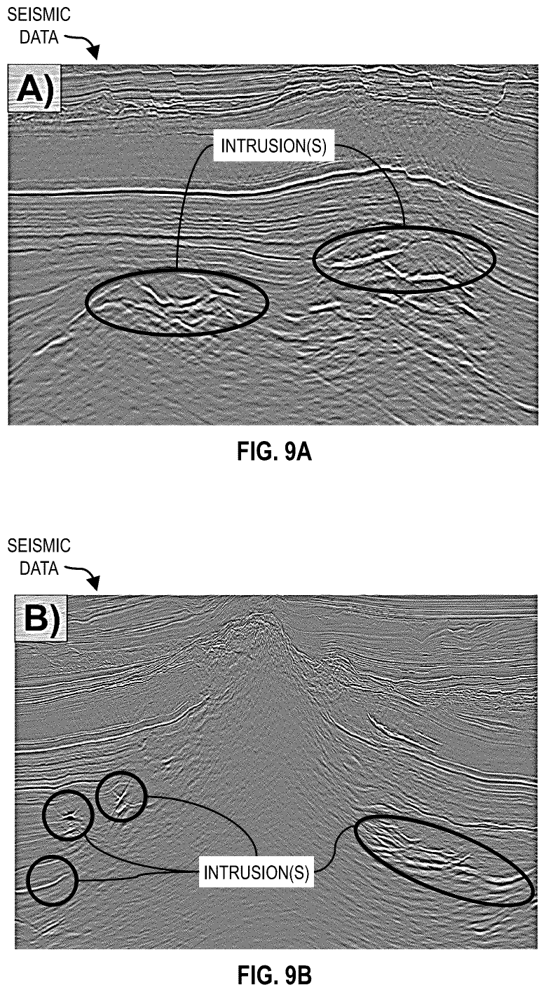

In Step 314, it is determined whether there are any diagnostic igneous features present in the seismic data such as igneous intrusions (FIG. 9A and FIG. 9B). As known to those of ordinary skill, and as used herein, an “intrusion” is a body of intrusive igneous rock, such as formed by crystallization of magma slowly cooling below the surface of the Earth. In one or more examples, magmatic intrusions may be well-imaged in seismic data as they possess a high amplitude character, are semi-continuous with abrupt terminations, and display complex geometries (e.g., saucer shaped). In one or more examples, the identification of igneous intrusions, and the resulting score, may be conducted manually or in an automated way.

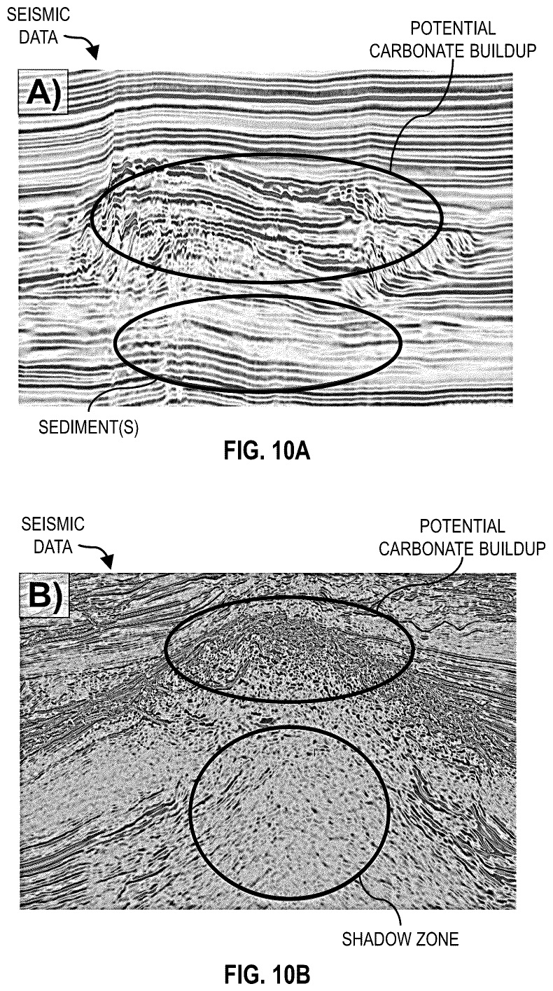

In Step 316, it is determined whether sediments are visible immediately below the feature of interest. In one or more examples, steep dips, internal heterogeneity, and higher velocity than surrounding sediments often result in the near complete disruption of the continuity of the reflections below volcanoes (FIG. 10B). The “shadow zones” (as seen in FIG. 10B) are not seen below carbonate buildups (e.g., not present in FIG. 10A). However, shadow zones may occur below carbonate buildups if the buildup initiated on anisotropic rocks (e.g., basement). In one or more examples, a higher score (closer or equal to 1) may be provided in cases where sediments are clearly visible and a lower score (closer or equal to 0) may be provided for the presence of a shadow zone.

In Step 318, a score for each parameter (see FIG. 12) is calculated to quantify the presence (or lack thereof) of one or more features in the data. In one or more examples, a pre-populated matrix (e.g., FIG. 12) of known carbonate build-ups and volcanoes may be used to train a machine learning (ML) algorithm to predict the nature of a feature in the subterranean formation. In one or more examples, the ML algorithm provides a confidence in its predictions. It is possible to use one or more algorithms from a range of types (e.g., neural network, tree-based) for this purpose. In turn, with the score for each parameter, it is then possible to rank the prospective parameter calculations. Further, when making a decision on whether to continue or change an exploration/injection strategy, such a decision may consider the weight/score assigned to the parameters. Importantly, any decision to continue or change an exploration/injection strategy has enormous economic, environmental, and commercial impact.

In Step 320, the score for each parameter is provided to the machine learning model. In turn, the machine learning model uses one or more algorithms (e.g., a neural network) to process the inputs and generate a composite score. In one or more examples, the machine learning model provides a weight to each of the parameters to indicate a comparative importance to the other parameters. The weight of each parameter may be calculated when the machine learning model is trained.

In Step 322, a decision is made as to whether exploration of the site should continue based on the output (prediction and probability) of the machine learning model. In one or more examples, a decision may be based on weighted score provided by the model. In one or more examples, one or more user(s) of the system may review the output result of the machine learning model, analyze the results, and make a determination as to whether exploration should continue based on the professional judgement of those user(s).

FIG. 4A is an image of a visualization of seismic data 402 showing potential carbonate buildups 404.

FIG. 4B is another image of a visualization of seismic data 406 showing potential carbonate buildups 408.

FIG. 5A is a global map 502 of a geographic (climate) regions with zones indicating likelihood of carbonate buildup existence. In particular, a first zone 504 is a region having a lower likelihood of occurrence of carbonate buildup, a second zone 506 is a region having a greater likelihood of occurrence of carbonate buildup, and a third zone 508 is another region having a lower likelihood of occurrence of carbonate buildup.

Similarly FIG. 5B is a global map 510 of a paleoclimate regions with zones indicating likelihood of carbonate buildup existence. In particular, FIG. 5B shows regions 512 with a greater likelihood of occurrence of carbonate buildup, and regions 514 with a lower likelihood of occurrence of carbonate buildup.

FIG. 6A is an image of a visualization 602 of seismic data showing a potential carbonate buildup and surrounding (substantially parallel) interpreted fault lines 604. FIG. 6B is an image of a visualization 606 of seismic data showing a potential carbonate buildup and surrounding (substantially radial) fault lines 608. It is to be noted that in the carbonate buildup of FIG. 6A, the interpreted fault lines 604 are in one preferential direction, whereas in the volcano of FIG. 6B, there is a radial pattern of interpreted fault lines 608, and hence a large variability in fault orientations

FIG. 7A is an image of a visualization 702 of amplitude extraction from seismic data showing features indicative of a carbonate buildup.

FIG. 7B is an image of a visualization 704 of amplitude extraction from seismic data showing features not indicative of a carbonate buildup.

FIG. 8 shows a bathymetric distribution 802 of modern carbonate buildups at varying depths. In one or more examples, the x-axis (DEM) is the depth of water, and the y-axis is the density of carbonate matter. In one or more examples, carbonate buildups are most likely to occur within 0-20 meters, with very little likelihood occurring below 200 meters.

FIG. 9A is an image of a visualization 902 of seismic data showing intrusions 904. FIG. 9B is an image of a visualization 906 of seismic data showing intrusions 908.

FIG. 10A is an image of a visualization 1002 of seismic data showing continuous sediment layers 1006 below potential carbonate buildup 1004. FIG. 10B is an image of a visualization 1008 of seismic data showing a shadow zone 1012 below potential carbonate buildup 1010.

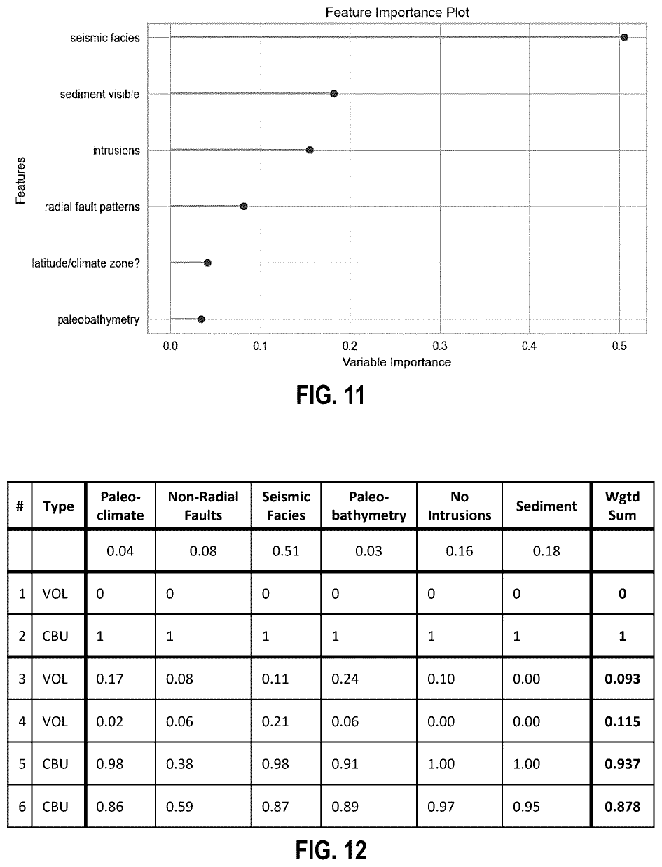

FIG. 11 is a bar chart showing the relative weight given to each parameter used to analyze the provided data. FIG. 12 is a table showing values calculated or assigned to each parameter for multiple use cases and examples of analyzed seismic data. In one or more examples, a table of scores is produced for each of a plurality of features (e.g., paleobathymetry, paleoclimate, etc. . . . ) of the potential buildup. These scores form the features used, either manually or by other means such as by a machine learning algorithm, to predict whether each feature is a buildup or not. The bar chart of FIG. 11 may be the output of a trained machine learning algorithm showing the relative importance of the different features.

Non-limiting examples of parameters may include: whether the site of the formation is located in a paleoclimate that would have been suitable to the accumulation of carbonate buildup (e.g., as identified in step 302) (see e.g., FIGS. 5A and 5B), whether the fault lines in the seismic data arc radial (indicating presence of a volcano) or parallel (indicating presence of carbonate buildup) (e.g., as identified in steps 304, 306) (see e.g., FIGS. 6A and 6B), presence of seismic facies indicative of carbonate buildup (e.g., reefs) (e.g., as identified in steps 308, 310) (see e.g., FIGS. 7A and 7B), the paleo-bathymetric depth of the feature of interest, conducive to carbonate buildup (e.g., 0-20 meters, 0-200 meters) (e.g., as identified in step 312) (see e.g., FIG. 8), the presence of diagnostic igneous features in the seismic data such as igneous intrusions (e.g., as identified in step 314) (see e.g., FIGS. 9A and 9B), the presence of “shadow zone(s)” beneath the feature of interest, shown as sediment layers present in the seismic data (e.g., as identified in step 316) (see e.g., FIGS. 10A and 10B), and/or any other seismic image attributes.

In one or more examples, seismic image attributes may also be used in the processing of the seismic data to aid in the identification of carbonate buildups, and to allow for the steering of a rotatable steering system (RSS) to access desirable regions and avoid undesirable regions. As a non-limiting example, seismic image attributes may indicate the differences in the transmissive behavior of the rock material mass, as well as any differences in overburden signatures due to growth compared to an intrusive/plutonic or an extrusive/volcanic habit. Non-limiting examples of seismic image attributes may include coherency, “sweetness,” chaos, instantaneous frequency, and/or any machine learning-derived attributes.

In one or more examples, parameters may be normalized (e.g., on scale from 0 to 1), where (as an example) 1 is representative of ideal conditions for the formation of carbonate buildup and 0 is representative of conditions not conducive for the formation of carbonate buildup.

In one or more examples, a machine learning model may be trained using one or more of the parameters above (e.g., including training based on seismic image attributes) to obtain a training output. As a non-limiting example, a machine learning model may be provided with a historical database of seismic data and/or historical paleoclimate data for known carbonate buildups and volcanoes (e.g., the historical data is labeled). In turn, the machine learning model may be trained to provide training output identifying (or otherwise providing a “confidence” score to) the presence of a carbonate buildup (or volcano).

In one or more examples, when training the machine learning model, various parameters may be given more (or less) comparative weight indicative of their importance in identifying carbonate structures. As a non-limiting example, as shown in FIG. 11, the “seismic facies” parameter is given more weight than any other parameter. Conversely, “paleobathymetry” is given little weight compared to each other parameter. In one or more examples, the sum of total weights may equal 1 (e.g., if the weight of each parameter is added, the total may equal 1.00).

When trained, the machine learning model may be provided with data relating to a subterranean feature of interest (which is truly unknown to be a carbonate buildup or volcanic structure). In turn, the machine learning model may produce an output including a score indicating the likelihood of a carbonate buildup. To do this, a score may be given to each of the parameters (for any given set of data). Such a score may be set manually, calculated automatically (e.g., by the machine leaning model), or semi-automatically calculated. When a value is calculated for each of the parameters, an overall weighted sum may be calculated for the individual data (e.g., sec “Wgtd Sum” in FIG. 12). In one or more examples, a weighted sum may be calculated by multiplying the individual parameter score with the weight assigned to that parameter, then summing each of the products (e.g., for example #5 in FIG. 12, (0.98×0.04)+(0.38×0.08)+(0.98×0.51)+(0.91×0.03)+(1.00×0.16)+(1.00×0.18)=0.937). Further, a confidence score may be calculated for the weighted sum output, where the confidence score indicates a strength in the calculated weighted sum.

In one or more examples, the machine learning model may be trained using supervised or unsupervised methods. The machine learning model may be of any type (neural network, decision tree, etc.). Further, the machine learning model may include multiple types of models therein in any possible configuration (e.g., series, parallel, or combination) (e.g., a convolutional neural network in series with a random forest tree, a probabilistic neural network in parallel with multi-layer perceptron network, a decision tree in parallel with two neural networks in series, etc.).

As it is impracticable to disclose every conceivable example of the technology described herein, the figures, examples, and description provided herein disclose only a limited number of potential examples. A person of ordinary skill in the relevant art would appreciate that any number of potential variations or modifications may be made to the explicitly disclosed examples, and that such alternative examples remain within the scope of the broader technology. Accordingly, the scope should be limited only by the attached claims. Further, the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces. Certain technical details, known to those of ordinary skill in the relevant art, may be omitted for brevity and to avoid cluttering the description of the novel aspects.

For further brevity, descriptions of similarly named components may be omitted if a description of that similarly named component exists elsewhere in the application. Accordingly, any component described with respect to a specific figure may be equivalent to one or more similarly named components shown or described in any other figure, and each component incorporates the description of every similarly named component provided in the application (unless explicitly noted otherwise). A description of any component is to be interpreted as an optional example, which may be implemented in addition to, in conjunction with, or in place of an example of a similarly-named component described for any other figure.

As used herein, adjective ordinal numbers (e.g., first, second, third, etc.) are used to distinguish between elements and do not create any ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” may be used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for the transmission of data. For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

As used herein, indefinite articles “a” and “an” mean “one or more”. That is, the explicit recitation of “an” clement does not preclude the existence of a second element, a third element, etc. Further, definite articles (e.g., “the” and “said”) mean “any one of” (the “one or more” elements) when referring to previously introduced element(s). As an example, there may exist “a processor”, where such a recitation does not preclude the existence of any number of other processors. Further, “the processor receives data, and the processor processes data” means “any one of the one or more processors receives data” and “any one of the one or more processors processes data”. It is not required that the same processor both (i) receive data and (ii) process data. Rather, each of the steps (“receive” and “process”) may be performed by different processors.

As used herein, “machine” means any collection of components assembled to form a tool, structure, or other apparatus. A collection of components may be grouped together and referred to as a single ‘machine’ based on the functionality of the machine enabled by the combination of the components. As a non-limiting example, a “car engine” is a machine assembled from the components of an engine block, one or more piston(s), a camshaft, etc. that, when combined, function to convert chemical energy into mechanical energy. Further, a machine may be constructed using one or more other machine(s). As a non-limiting example, an automobile may be an assembly of a car engine, a drivetrain, and a steering system—each an independent machine—but assembled to form a larger machine, singularly referred to as an “automobile” which functions to provide transportation.

As used herein, “real-time” may be generally understood to relate to a system, apparatus, or method in which a set of input data is available for use within 100 milliseconds (“ms”). Additionally, as used herein, “real-time” may refer to any duration of time to acquire and/or otherwise process data that is sufficiently short enough for a human to believe the data is providing an up-to-date and/or accurate representation of the underlying system. Accordingly, “real-time” may be context specific. As a first non-limiting example, 20 ms (or less) may be the maximum allowable latency to avoid inducing nausea in a human using a virtual reality headset (i.e., providing “real-time” sensory stimulation for motion detected by the inner ear and motion detected by eyesight). As a second non-limiting example, motor vibration data that is displayed on a monitor one second after the vibration occurred may be considered “real-time”. And, as a third non-limiting example, measured movements of Earth's tectonic plates—obtained and processed only once per day—may be considered “real-time”.

What is claimed is:

1. A method for analyzing seismic data of a subterranean formation, comprising:
obtaining the seismic data;
identifying one or more potential carbonate buildups in the seismic data;
obtaining historical paleoclimate data for the formation of the one or more potential carbonate buildups;
processing the seismic data and the historical paleoclimate data to generate a plurality of parameter scores for a plurality of characteristics of the formation; and
calculating a weighted sum of the parameter scores using a plurality of parameter weights.

2. The method of claim 1, further comprises:
using the weighted sum of parameter scores to train a machine learning model using a historical database of the seismic data and the historical paleoclimate data.

3. The method of claim 2, wherein training the machine learning model comprises:
obtaining historical seismic data from the historical database;
analyzing the historical seismic data; and historical paleoclimate data;
generating a training output; and
modifying the machine learning model based on the training output.

4. The method of claim 1, wherein processing the seismic data includes identifying differences in a transmissive behavior of a rock material mass in the seismic data.

5. The method of claim 1, wherein processing the seismic data includes identifying differences in an overburden signature in the seismic data, wherein the overburden signature is due to a growth, intrusive habit, or extrusive habit.

6. The method of claim 1, wherein processing the seismic data includes identifying an azimuthal attribute in the seismic data, wherein the azimuthal attribute represents azimuthal features with respect to faults and fractures in the subterranean formation.

7. The method of claim 1, wherein the seismic data is obtained utilizing at least one seismic source and at least one hydrophone.

8. A system for analyzing seismic data of a subterranean formation, comprising:
a processor for processing the seismic data to generate a plurality of parameter scores;
calculating a weighted sum of the parameter scores using a plurality of parameter weights; and
providing the weighted sum as an output.

9. The system of claim 8, wherein prior to obtaining the seismic data, further comprising:
a processor executing program instructions for training a machine learning model using a historical database of the seismic data.

10. The system of claim 9, wherein training the machine learning model comprises:
obtaining historical seismic data from the historical database;
analyzing the historical seismic data;
generating a training output; and
modifying the machine learning model based on the training output.

11. The system of claim 9, wherein processing the seismic data includes identifying differences in a transmissive behavior of a rock material mass in the seismic data.

12. The system of claim 8, wherein processing the seismic data includes identifying differences in an overburden signature in the seismic data, wherein the overburden signature is due to a growth, intrusive habit, or extrusive habit.

13. The system of claim 8, wherein processing the seismic data includes identifying an azimuthal attribute in the seismic data, wherein the azimuthal attribute represents azimuthal features with respect to faults and fractures in a subterranean formation represented by the seismic data.

14. A computer-readable medium tangibly embodying instructions that, when executed by a processor, performs a method for analyzing seismic data of a subterranean formation, the method comprising:
obtaining the seismic data;
processing the seismic data to generate a plurality of parameter scores;
calculating a weighted sum of the parameter scores using a plurality of parameter weights; and
providing the weighted sum as an output.

15. The computer-readable medium of claim 14, wherein the method further comprises:
training a machine learning model using a historical database of the seismic data.

16. The computer-readable medium of claim 15, wherein training the machine learning model, comprises:
obtaining historical seismic data from the historical database;
analyzing the historical seismic data;
generating a training output; and
modifying the machine learning model based on the training output.

17. The computer-readable medium of claim 14, wherein processing the seismic data includes identifying differences in a transmissive behavior of a rock material mass in the seismic data.

18. The computer-readable medium of claim 14, wherein processing the seismic data includes identifying differences in an overburden signature in the seismic data, wherein the overburden signature is due to a growth, intrusive habit, or extrusive habit.

19. The computer-readable medium of claim 14, wherein processing the seismic data includes identifying an azimuthal attribute in the seismic data, wherein the azimuthal attribute represents azimuthal features with respect to faults and fractures in the subterranean formation.

20. The computer-readable medium of claim 14, wherein the seismic data is obtained utilizing at least one seismic source and at least one hydrophone.
